(19) United States
(12) Patent Application Publication
(10) Pub. No.: US 2006/0133873 A1
(43) Pub. Date: Jun. 22, 2006

(54) Belt drive controlling method, belt drive controlling apparatus, belt apparatus, image forming apparatus, and computer product

(76) Inventors: Toshiyuki Andoh, Kanagawa (JP); Hiromichi Matsuda, Kanagawa (JP); Nobuto Yokokawa, Kanagawa (JP); Ryoji Imai, Kanagawa (JP); Yuji Matsuda, Tokyo (JP); Hiroshi Okamura, Kanagawa (JP); Kazuhiko Kobayashi, Tokyo (JP); Yohei Miura, Tokyo (JP); Masato Yokoyama, Kanagawa (JP)

Correspondence Address: HARNESS, DICKEY & PIERCE, P.L.C., P.O. BOX 8910, RESTON, VA, 20195, US

(21) Appl. No.: 11/311,139

(22) Filed: Dec. 20, 2005

(30) Foreign Application Priority Data
Dec. 20, 2004 (JP) 2004-367129

(51) Int. Cl. G03G 15/00

(52) U.S. Cl. 399/388

(57) ABSTRACT

An endless belt is spanned around at least one driving member and at least one supporting member. The driving member is driven by a pulse motor. An angular displacement of the driving member is detected, a difference between detected angular displacement and a target angular displacement is calculated, a frequency of a driving pulse used to drive the pulse motor is calculated based on the difference and a reference driving pulse frequency, and the pulse motor is controlled based on a driving pulse with calculated frequency. The target angular displacement is set so as to cancel a specific velocity fluctuation component of a surface velocity of the belt produced when the drive member is rotated at a constant angular velocity and that is smaller than amount of surface movement of the belt in one driving pulse.

### CROSS-REFERENCE TO RELATED APPLICATIONS

The present document incorporates by reference the entire contents of Japanese priority document, 2004-367129 filed in Japan on Dec. 20, 2004.

### BACKGROUND OF THE INVENTION

1. Field of the Invention

The present invention generally relates to a technology for controlling driving of an endless belt, and more specifically relates to controlling driving of an endless belt in an image forming apparatus.

2. Description of the Related Art

An endless belt spanned around rotating or non-rotating members is used in image forming apparatuses. To maintain the velocity of such a belt constant, a target velocity of the belt is set and the velocity of the belt is maintain at the target velocity based on a feedback control using the real velocity of the belt.

For example, Japanese Patent Application Laid-open No. 2004-187413 discloses to perform a feedback control on a pulse motor such that a belt, which is spanned around a roller (driving or idle roller), driven by the pulse motor rotates at a constant velocity. An angular displacement of the roller is detected, a difference between the angular displacement and a target angular displacement is obtained, and the driving pulse frequency of a driving pulse signal used to drive the pulse motor is calculated based on the difference and a reference driving pulse frequency. The pulse motor is driven using a driving pulse signal having the calculated driving pulse frequency. As a result, the pulse motor can be rotated such that the belt moves at a target velocity.

The velocity of an endless belt can fluctuate due to various factors. One of the factors is a variation in the thickness of the belt. In other words, if the belt thickness fluctuates, even if the pulse motor, or the roller, rotates at a constant velocity, the velocity of the belt will vary. The deviation between a specific point on the belt when the belt is rotated at a constant velocity and when the roller is rotated at the constant velocity is very small, i.e., smaller than the distance the belt moves with one driving pulse. It has long been believed that such small deviations of the belt cannot be suppressed.

A graph shown in FIG. 14 exemplifies a deviation amount (a solid line) between a point (a predetermined belt position) where, when a belt is moved on a surface at a constant surface-moving velocity, a position (a belt position) of a reference mark on a surface of the belt is positioned, and a belt position obtained when minute velocity fluctuation occurs due to thickness fluctuation of the belt or the like in a time elapsing manner. When the minute velocity fluctuation is suppressed, it appears that it can be made possible to cause the fluctuated belt position to coincide with the predetermined belt position by setting the target value such that the deviation amount to the predetermined belt position simply takes a belt position indicated by a double-dotted line in FIG. 14 and driving the pulse motor to follow the target value.

However, the deviation amount of the belt position due to the minute velocity fluctuation component shown in FIG. 14 is smaller than a moving amount (a dotted line in FIG. 14) of the belt moved when one driving pulse signal is inputted into the pulse motor. To correct such a deviation amount to cause the fluctuated belt position to follow the predetermined belt position, it is necessary to adjust the fluctuated belt position by a position error amount smaller than the belt moving amount. However, it has been thought that the deviation amount of the fluctuated belt position that can be controlled by the pulse motor is in a range of at least a deviation amount corresponding to a belt moving amount per one driving pulse signal and a fluctuation amount of position smaller than the belt moving amount cannot be adjusted. Accordingly, it has not been achieved yet to set a target value such that the deviation amount of the fluctuated belt position coincides with the belt position shown by a double-dotted line in FIG. 14 to cancel the minute velocity fluctuation.

According to the conventional concept, it has been thought that it is difficult to suppress the following minute velocity fluctuation.

In a tandem image forming apparatus of direct transfer system including four photoconductors, for example, it is assumed that a recording member conveying belt with a thickness error of 10 micrometers has been used. When a driving roller around which the recording member conveying belt is spanned is driven at an equal angular velocity by a pulse motor, an amplitude of thickness fluctuation of the belt contributing to the velocity fluctuation of the recording member conveying belt will be about ±2.5 micrometers. The value of the amplitude is ordinarily obtained when a radius of the driving roller is set to 17 millimeters and an average thickness of the recording member conveying belt is set to 100 micrometers. When a turning angle of the recording member conveying belt around the driving roller is sufficiently large, ±1.47×10⁻⁴ radians is obtained by converting the value of the amplitude to an angular displacement amount. To adjust such deviation of the angular displacement amount of the driving roller using the pulse motor, it is necessary to provide a driving system that can adjust an angular displacement amount of the driving roller corresponding to about 1/10 of an angular displacement amount of the pulse motor per one driving pulse signal according to the above-described conventional concept. That is, the angular displacement amount of the driving roller must be controlled for each 1.47×10⁻⁵ radians. Since an ordinary pulse motor rotates by 1.8 degrees, namely, 0.0314 radian per one driving pulse signal, it is necessary to realize a reduction ratio of about 1/2100 utilizing a combination of a reduction mechanism, a micro-step, and the like in a driving and transmitting mechanism including the pulse motor and the driving roller to control the angular displacement amount of the driving roller for each 1.47×10⁻⁵ radians utilizing the pulse motor as a driving source. An expensive driver is generally required for the micro-step exceeding a reduction ratio of 1/8, or a reduction mechanism with a high reduction ratio must be constituted using a gearwheel with a large diameter or it needs to have a multi-tier configuration. Accordingly, realization of such a large reduction ratio as about 1/2100 causes cost elevation and requires a large space for storing equipment, and therefore, it is unrealistic.

However, it has been confirmed that, even if the amplitude of the thickness fluctuation of the belt contributing to the velocity fluctuation of the recording member conveying belt is ±10 micrometers, out of color registration of about 70 micrometers occurs in an image on a recording member. Since an image with high quality where the out of color registration has been suppressed to about 20 micrometers is demanded currently, it is necessary to suppress the amplitude of the thickness fluctuation of the belt contributing to the velocity fluctuation of the recording member conveying belt to about ±2.8 micrometers.

### SUMMARY OF THE INVENTION

It is an object of the present invention to at least solve the problems in the conventional technology.

According to an aspect of the present invention, a method of controlling driving of an endless belt spanned around at least one driving member and at least one supporting member, the driving member being driven by a pulse motor includes detecting angular displacement of at least one of the driving member and the supporting member; calculating a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse; calculating a frequency of a driving pulse used to drive the pulse motor based on the difference and a reference driving pulse frequency; and driving the pulse motor based on a driving pulse with calculated frequency.

According to another aspect of the present invention, a belt drive controlling apparatus that controls driving of an endless belt spanned around at least one driving member and at least one supporting member, the driving member being driven by a pulse motor includes an angular displacement detecting unit that detects detecting angular displacement of at least one of the driving member and the supporting member; a difference calculating unit that calculates a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse; a frequency calculating unit that calculates a frequency of a driving pulse used to drive the pulse motor based on the difference and a reference driving pulse frequency; and a driving unit that controls driving of the pulse motor based on a driving pulse with calculated frequency.

According to still another aspect of the present invention, a belt apparatus includes a belt drive controlling apparatus according to the present invention.

According to still another aspect of the present invention, an image forming apparatus includes a belt apparatus according to the present invention.

According to still another aspect of the present invention, a computer-readable recording medium stores therein a computer program that causes a computer to implement the method of controlling driving of an endless belt according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a belt apparatus according to a first embodiment of the present invention;

FIG. 2 is a block diagram of a belt drive controlling apparatus shown in FIG. 1;

FIG. 3 is a block diagram of a hardware configuration of a control system for a pulse motor and a controlling target thereof according to the first embodiment;

FIG. 4 is a graph depicting, by a solid line, an accumulation position of a belt including a belt position error due to thickness fluctuation of the belt when the pulse motor is rotated at a constant angular velocity;

FIG. 5 is a graph depicting an accumulation position of a belt obtained by subtracting an inclination component from the measurement result shown in FIG. 4;

FIG. 6 is a perspective view of a belt apparatus according to a second embodiment of the present invention;

FIG. 7 is a block diagram of a hardware configuration of a control system for a pulse motor and a controlling target thereof according to the second embodiment;

FIG. 8 is a block diagram of a drive controlling apparatus according to a modification of the first or the second embodiment;

FIG. 9 is a schematic of a color copying machine according to a third embodiment of the present invention;

FIG. 10 is a schematic of a color copying machine according to a fourth embodiment of the present invention;

FIG. 11 is a schematic of a color copying machine according to a fifth embodiment of the present invention;

FIG. 12 is a schematic of an image reader according to a sixth embodiment of the present invention;

FIG. 13 a schematic of a personal computer that can suitably implement a method according to the above embodiments; and

FIG. 14 is a graph to explain an amount of deviation between a predetermined belt position and a belt position including a minute velocity fluctuation component.

### DETAILED DESCRIPTION OF THE PREFERRED EMBODIMENTS

Exemplary embodiments of the present invention will be explained below with reference to the accompanying drawings.

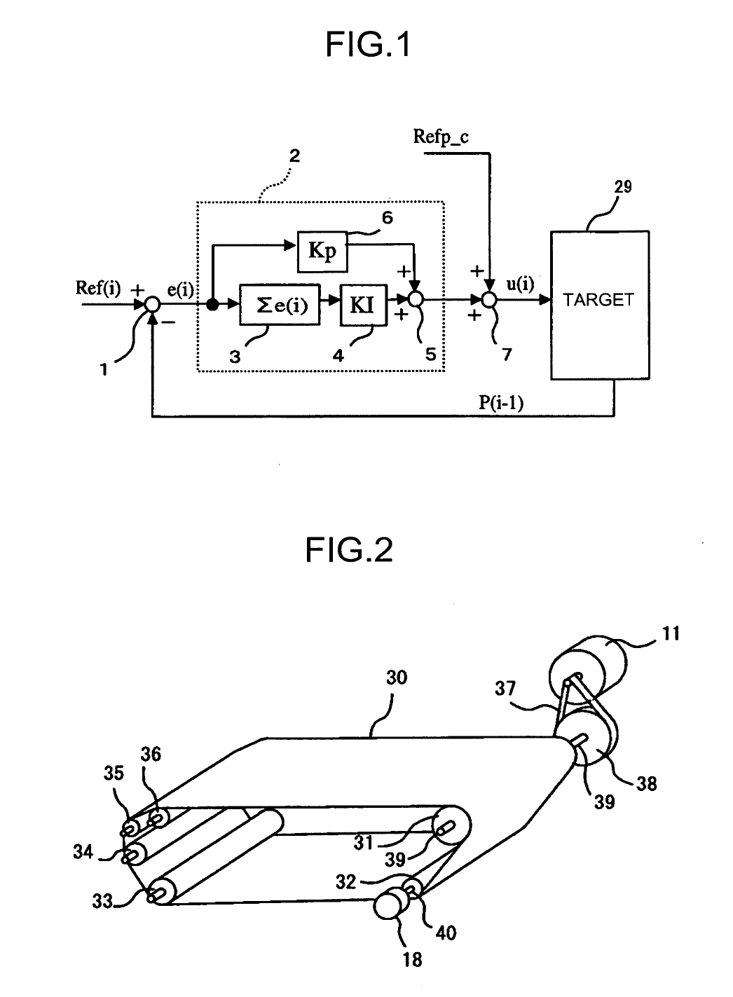

FIG. 1 is a perspective view of a belt apparatus according to a first embodiment of the present invention. The belt apparatus includes a belt drive controlling apparatus that controls driving of a pulse motor 11 such that an endless belt 30 spanned around a driving roller 31 and idle rollers 32 to 36 moves at a predetermined constant velocity. In FIG. 1, a rotational torque (a driving force) of the pulse motor 11 is transmitted to a driving shaft 39 of the driving roller 31 around which the belt 30 is spanned via a reduction system constituting a power transmission system, for example, a timing belt 37 and an idle pulley 38. When a rotational driving force of the pulse motor 11 is transmitted to the driving roller 31, the belt 30 spanned around the driving roller 31 moves. In the first embodiment, an angular displacement of the idle roller 32 positioned near the driving roller 31 is detected. A unit for detecting the angular displacement of the idle roller 32 includes an encoder 18 attached to an idle shaft 40 of the idle roller 32 via a coupling (not shown). The encoder can be a known rotary encoder or a known linear encoder.

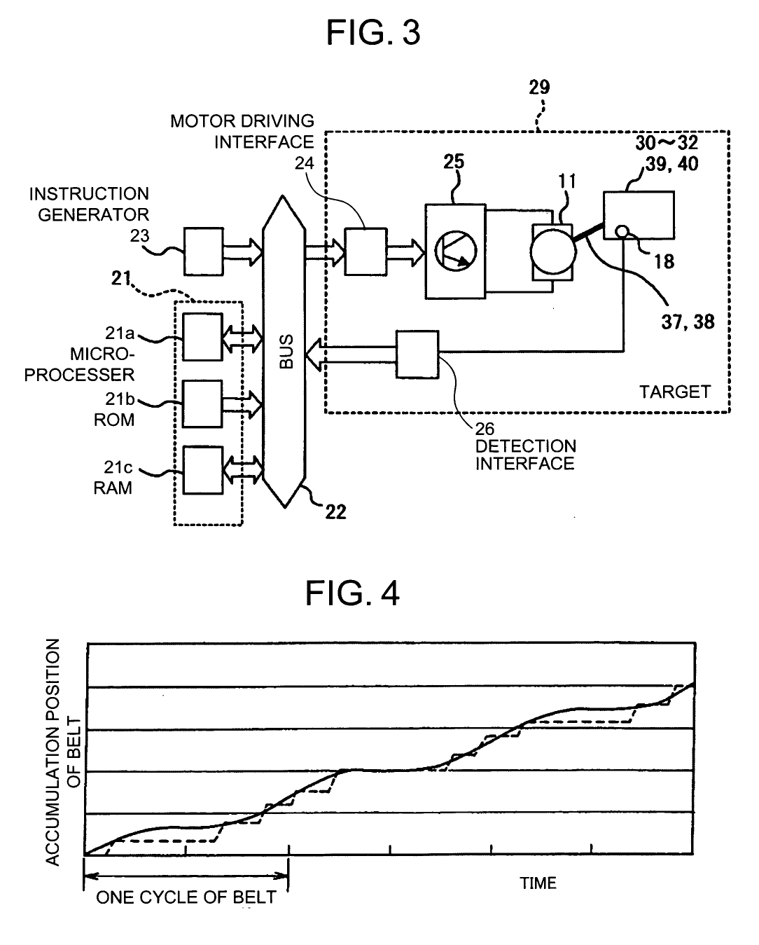

FIG. 3 is a block diagram of a hardware configuration of a control system for the pulse motor 11 and a controlling target thereof according to the first embodiment. The control system is a control system that digitally controls an angular displacement of the pulse motor 11 based on an output signal from the encoder 18.

The control system includes a microcomputer 21, a bus 22, an instruction generator 23, a motor driving interface 24, a motor driving apparatus 25 serving as a motor driving unit, and a detection interface 26.

The microcomputer 21 includes a microprocessor 21a, a read only memory (ROM) 21b, a random access memory (RAM) 21c, and the like. The microprocessor 21a, the ROM 21b, the RAM 21c and the like are connected to one another via the bus 22, respectively.

The instruction generator 23 outputs an instruction signal instructing a drive frequency of a driving pulse signal to the pulse motor 11. An output of the instruction generator 23 is also connected to the bus 22.

The detection interface 26 processes an output pulse from the encoder 18 to convert the same to a digital numeral. The detection interface 26 includes a counter for counting the number of output pulses from the encoder 18, where conversion to a digital numeral corresponding to the angular displacement of the idle roller 32 is performed by multiplying a numerical value counted by the counter by a conversion constant of pulse number to angular displacement preliminarily determined. A signal indicating the digital numerical value corresponding to the angular displacement of the idle roller 32 is fed to the microcomputer 21 via the bus 22. A sampling period is set to be sufficiently finer than an anti-aliasing frequency.

Based on an instruction signal for a driving frequency fed from the instruction generator 23, the motor driving interface 24 generates a pulse-like control signal having the driving frequency.

The motor driving apparatus 25 includes a power semiconductor device (for example, a transistor) and the like. The motor driving apparatus 25 operates based on the pulse-like control signal outputted from the motor driving interface 24 to apply a pulse-like driving voltage to the pulse motor 11. As a result, driving of the pulse motor 11 is controlled by a predetermined driving frequency outputted from the instruction generator 23. Thereby, follow-up control is performed such that the angular displacement of the idle roller 32 follows a target angular displacement and the belt 30 spanned around the idle roller 32 moves at a predetermined equal velocity. The angular displacements of the idle roller 32 are detected by the encoder 18 and the detection interface 26, and it is taken in the microcomputer 21 so that control is repeated.

A portion indicated by reference numeral 29 in FIG. 3 is a target to be controlled including the whole belt driving system shown in FIG. 1, the motor driving interface 24, the motor driving apparatus 25, and the detection interface 26.

FIG. 2 is a block diagram of a drive controlling apparatus for implementing the drive controlling method according to the first embodiment. In FIG. 2, a detection angular displacement P(i-1) of the driving roller 31 outputted from the detection interface 26 for processing an output pulse signal from the encoder 18 is inputted into a calculator 1. The calculator 1 calculates a difference e(i) between a target angular displacement Ref(i) of the driving roller 31 that is a control target value and the detection angular displacement P(i-1) of the driving roller 31. The difference e(i) is inputted into a controller 2. The controller 2 includes, for example, a PI controlling system. The difference e(i) calculated in the calculator 1 is integrated by an integrator 3 and multiplied by a constant KI in a proportional element 4 to be inputted to a calculator 5. Simultaneously, the difference e(i) calculated in the calculator 1 is multiplied by a constant KP in a proportional element 6 to be inputted into the calculator 5. The calculator 5 obtains a correction amount to the reference driving pulse frequency used for driving the pulse motor 11 by adding two input signals from the respective proportional elements 4 and 6 to each other, and the correction amount is inputted into a calculator 7. In the calculator 7, the correction amount is added to a reference driving pulse frequency Refp_c, so that a driving pulse frequency u(i) is determined. A driving pulse signal is produced by the motor driving interface 24 and the motor driving apparatus 25 based on the driving pulse frequency u(i) of the driving signal obtained in the calculator 7 to be outputted into the pulse motor 11. A driving force of the pulse motor 11 thus drive-controlled is transmitted to the driving shaft 39 of the driving roller 31 via the drive transmission systems 37 and 38, so that the driving roller 31 rotates at an equal angular velocity according to a predetermined target angular displacement. As a result, the belt 30 moves at a predetermined equal velocity and the idle roller 32 rotates at a predetermined equal angular velocity. The control operation based on the feedback loop is repeated.

While in the controller 2 of the first embodiment, the PI control system has been used as one example, the controller is not limited to this example. All the above calculations have been performed according to numerical value calculation in the microcomputer 21, which can be realized easily. The reference driving pulse frequency Refp_c is the number of pulses uniquely determined according to the angular velocity based on a velocity and a belt driving radius of the belt 30 and a reduction ratio of the reduction system. In the first embodiment, it is also possible to arbitrarily select the number of pulses within a range where a step-out phenomenon does not occur during motor driving. The target angular displacement Ref(i) can be obtained easily by integrating the target equal angular velocity of the idle roller 32.

The target angular displacement Ref(i) is set to cancel a specific velocity fluctuation component of velocity fluctuation components of the surface-moving velocity of the belt 30 appearing when the driving roller 31 is rotated at a constant angular velocity, the specific velocity fluctuation component indicating a velocity fluctuation component where a deviation amount between a belt position of the belt 30 moving at a constant surface-moving velocity and a belt position obtained when the driving roller 31 is rotated at a constant angular velocity is smaller than a belt surface-moving amount per one driving pulse signal. For example, such a target angular displacement Ref(i) can be set as described below.

The pulse motor is first rotated at a constant angular velocity, where a belt velocity fluctuation component at the idle roller 32 and a phase difference from the belt reference position of the idle roller 32 are measured. An amplitude value of the belt velocity fluctuation component obtained is multiplied by a coefficient and a predetermined coefficient is added to the phase. A value thus obtained is set as a target value. These coefficients are uniquely determined according to a layout of the belt apparatus according to the first embodiment.

To explain specifically, a belt position error (a deviation amount) A that occurs in the belt surface-moving direction due to thickness fluctuation of the belt at a portion of the belt spanned around the driving roller 31 can be expressed by Equation 1. A belt position error B occurring in the belt surface-moving direction due to thickness fluctuation of the belt at a portion of the belt spanned around the idle roller 32 can be expressed by Equation 2:

$$\begin{matrix}A = \frac{{κ}_{d}}{{R}_{d} + {κ}_{d} {B}_{t0}} sin ( {D}_{d} {θ}_{d} + α ) & ( 1 ) \\ B = - \frac{{κ}_{e}}{{R}_{e} + {κ}_{e} {B}_{t0}} sin ( {D}_{d} {θ}_{d} + α + τ ) & ( 2 )\end{matrix}$$

R_{d} represents a roller effective radius of the driving roller 31, and Rₑ represents a roller effective radius of the idle roller 32. θ_{d} represents a turning angle of the belt 30 on the driving roller 31, and θₑ represents a turning angle of the belt 30 on the idle roller 32. κ_{d} represents a belt thickness effective coefficient determined according to the belt turning angle θ_{d} of the driving roller 31, material for the belt, a belt layer structure, or the like, and it is a parameter for determining a magnitude that the thickness of the belt influences a belt moving velocity V. Similarly, κₑ represents a belt thickness effective coefficient of the idle roller 32. Both of the belt thickness effective coefficients κ_{d} and κₑ ordinarily take 0.5, when a belt with even material having one layer structure is used and the belt turning angles θ_{d} and θₑ are sufficiently large. Bₜ₀ represents an average thickness of the belt 30. α represents an initial phase of the belt 30. D_{d} represents Equation 3. Σ represents a mean time (a delay time) required for the belt 30 to move from the driving roller 31 to the idle roller 32.
D_{d}=2π(R_{d}+κ_{d}Bₜₒ)/L_{b} (3)

A belt position error C corresponding to one cycle of the belt at a portion of the belt spanned on the idle roller 32 takes a composition value of the belt position error A and the belt position error B and it is expressed by Equation 4. K and β in Equation 4 can be obtained from Equations 5 and 6, respectively.
C=K sin(D_{d}θ_{d}+α+β) (4)

$$\begin{matrix}K = \sqrt{{( \frac{{κ}_{d}}{{R}_{d} + {κ}_{d} {B}_{t0}} )}^{2} + {( \frac{{κ}_{e}}{{R}_{e} + {κ}_{e} {B}_{t0}} )}^{2} - 2 \frac{{κ}_{d} {κ}_{e}}{( {R}_{d} + {κ}_{d} {B}_{t0} ) ( {R}_{e} + {κ}_{e} {B}_{t0} )} cos τ} & ( 5 ) \\ β = {tan}^{- 1} ( \frac{- \frac{{κ}_{e}}{{R}_{e} + {κ}_{e} {B}_{t0}} sin τ}{\frac{{κ}_{d}}{{R}_{d} + {κ}_{d} {B}_{t0}} - \frac{{κ}_{e}}{{R}_{e} + {κ}_{e} {B}_{t0}} cos τ} ) & ( 6 )\end{matrix}$$

In the first embodiment, since the angular displacement of the idle roller 32 is detected by the encoder 18, a detection result obtained when the belt is moved on a surface at an equal velocity corresponds to the belt position error indicated by the belt position error B. Accordingly, by performing control such that angular displacement corresponding to the belt position error C becomes equal to angular displacement corresponding to the belt position error B, the belt can be controlled to have an equal moving velocity. Therefore, from comparison between B shown by Equation 2 and C shown by Equation 4, it is understood that a value indicated by Equation 7 can be multiplied regarding the amplitude and −β+Σ is added regarding the phase. From the above, the target angular displacement Ref(i) can be produced.

$$- \frac{{κ}_{e}}{{R}_{e} + {κ}_{e} {B}_{t0}} \frac{1}{K} \qquad ( 7 )$$

There is a case that velocity fluctuation due to a minute belt velocity fluctuation component caused by thickness fluctuation of the belt can be reduced by setting the target angular displacement Ref(i) in the above manner and performing accumulation position control of the belt 30. This is explained below.

FIG. 4 is a graph depicting, by a solid line, an accumulation position of the belt 30 including a belt position error due to thickness fluctuation of the belt when the pulse motor 11 is rotated at a constant angular velocity. In the graph, the result obtained by using the target angular displacement Ref(i) to perform the accumulation position control is shown by a dotted line. As understood from the graph, regarding a minute belt velocity fluctuation component due to thickness fluctuation of the belt such that a deviation amount between a belt position of the belt 30 moving at a predetermined surface-moving velocity and a belt position thereof obtained when the driving roller 31 is rotated at a constant angular velocity is smaller than a belt surface-moving amount per one driving pulse signal, a velocity fluctuation of the belt due to the minute belt velocity fluctuation component can be suppressed sufficiently.

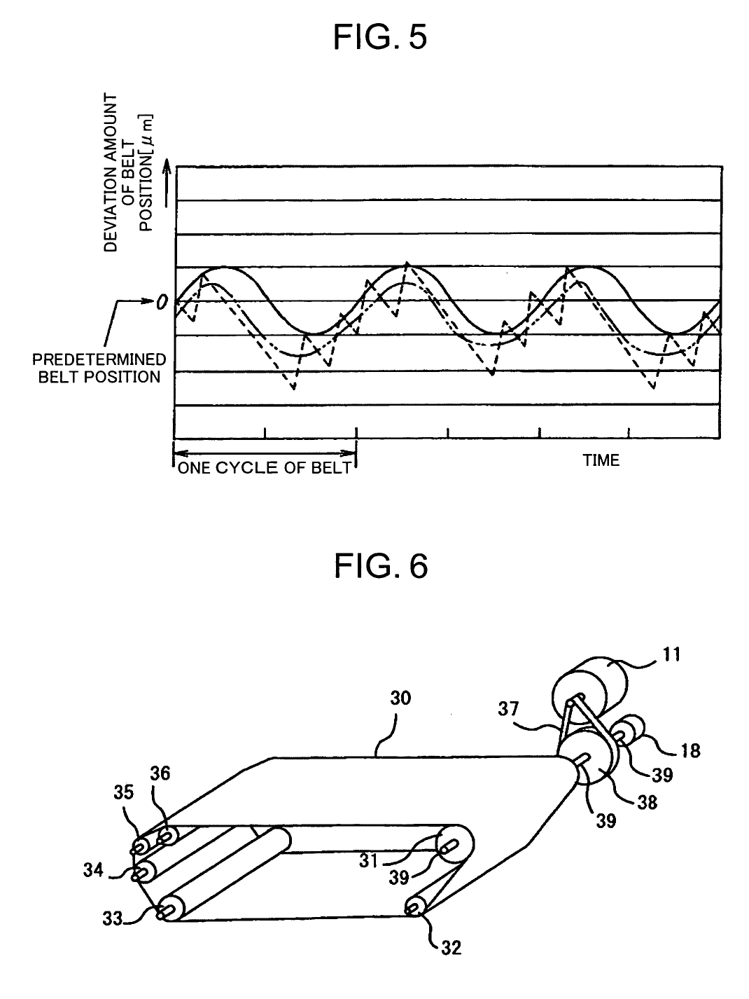

FIG. 5 is a graph depicting an accumulation position of a belt obtained by subtracting an inclination component from the measurement result shown in FIG. 4. That is, the graph indicates a deviation amount of the actual belt position to the predetermined belt position over time. According to FIG. 5, it is understood that the minute belt velocity fluctuation can be sufficiently suppressed as compared with the fluctuation shown in FIG. 4.

FIG. 6 is a perspective view of a belt apparatus according to a second embodiment of the present invention. The belt apparatus of the second embodiment includes a belt drive controlling apparatus that controls driving of a pulse motor 11 such that an endless belt 30 spanned around a driving roller 31 and idle rollers 32 to 36 moves at a predetermined constant velocity. In FIG. 6, a rotational torque (a driving force) of the pulse motor 11 serving as a driving source is transmitted to a driving shaft 39 of the driving roller 31 around which the belt 30 is spanned via a reduction system constituting a power transmission system, for example, a timing belt 37 and an idle pulley 38. When a rotational driving force of the pulse motor 11 is transmitted to the driving roller 31, the belt 30 spanned around the driving roller 31 moves on a surface. In the second embodiment, angular displacement of the driving roller 31 is detected. A unit that detects the angular displacement of the driving roller 31 includes an encoder 18 attached to the driving shaft 39 of the driving roller 31 via a coupling (not shown).

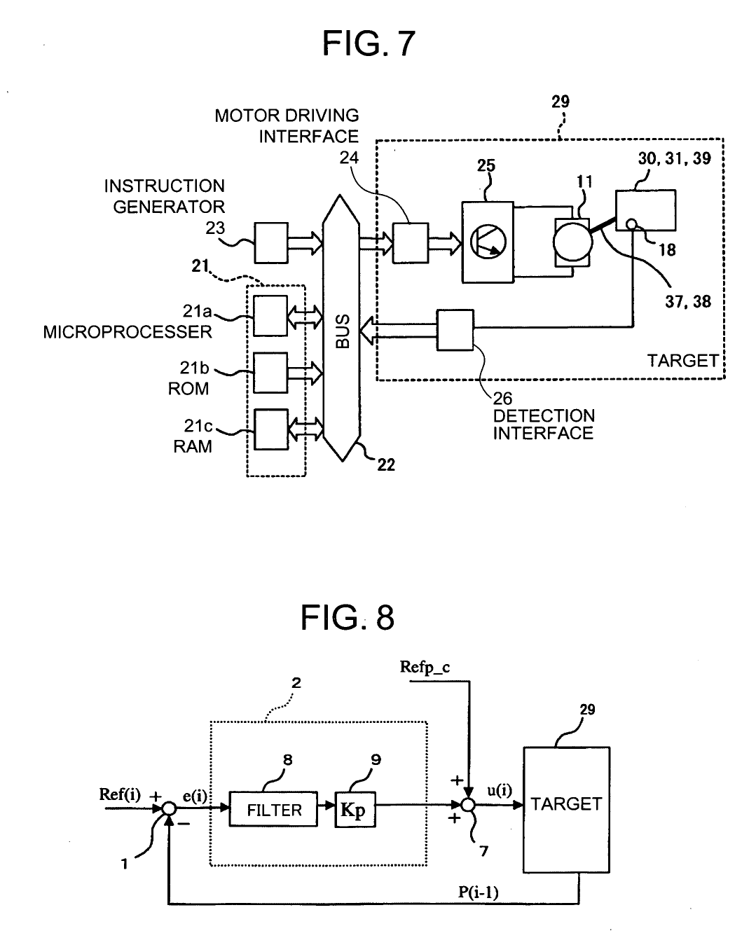

FIG. 7 is a block diagram of a hardware configuration of a control system for the pulse motor 11 and a target to be controlled according to the second embodiment. The control system digitally controls angular displacement of the pulse motor 11 based on an output signal from the encoder 18. In FIG. 7, respective parts in a hardware configuration similar to that in the first embodiment shown in FIG. 3 are designated with like reference numerals.

The detection interface 26 processes an output pulse from the encoder 18 to convert the same to a digital numeral. The detection interface 26 includes a counter for counting the number of output pulses from the encoder 18, where conversion to a digital numeral corresponding to the angular displacement of the idle roller 32 is performed by multiplying a numerical value counted by the counter by a conversion constant of pulse number to angular displacement preliminarily determined. A signal indicating the digital numerical value corresponding to the angular displacement of the idle roller 32 is fed to the microcomputer 21 via the bus 22.

The motor driving apparatus 25 operates based on a pulse-like control signal outputted from the motor driving interface 24 to apply a pulse-like driving voltage to the pulse motor 11. As a result, driving of the pulse motor 11 is controlled by a predetermined driving frequency outputted from the instruction generator 23. Thereby, follow-up control is performed such that the angular displacement of the idle roller 32 follows target angular displacement and the belt 30 spanned around the idle roller 32 moves at a predetermined equal velocity. The angular displacement of the driving roller 31 is detected by the encoder 18 and the detection interface 26, and they are taken in the microcomputer 21 so that control is repeated.

A block diagram of the drive controlling apparatus for implementing the drive controlling method according to the second embodiment is similar to that shown in FIG. 2 regarding the first embodiment. Information outputted from the detection interface 26 processing an output pulse signal from the encoder 18, namely, information about angular displacement of the driving roller 31 (hereinafter, “detection angle”) P(i-1) is inputted into a calculator (subtracter) 1. The calculator 1 calculates a difference e(i) between a target angular displacement Ref(i) of the driving roller 31 that is a control target value and a detection angular displacement P(i-1) of the driving roller 31. The difference e(i) is inputted into the controller 2. The controller 2 includes, for example, a PI control system. The difference e(i) calculated in the calculator 1 is integrated by the integrator 3 and multiplied by a constant KI in the proportional element 4 to be inputted to the calculator 5. Simultaneously, The difference e(i) calculated in the calculator 1 is multiplied by a constant KP in the proportional element 6 to be inputted into the calculator 5. The calculator 5 obtains a correction amount to the reference driving pulse frequency used for driving the pulse motor 11 by adding two input signals from the respective proportional elements 4 and 6 to each other, and it is inputted into the calculator 7. In the calculator 7, the correction amount is added to a reference driving pulse frequency Refp_c, so that a driving pulse frequency u(i) is determined. A driving pulse signal is produced by the motor driving interface 24 and the motor driving apparatus 25 based on the driving pulse frequency u(i) of the driving signal obtained in the calculator 7 to be outputted into the pulse motor 11. A driving force of the pulse motor 11 thus drive-controlled is transmitted to the driving shaft 39 of the driving roller 31 via the drive transmission systems 37 and 38, so that the driving roller 31 rotates at an equal angular velocity according to predetermined target angular displacement. As a result, the belt 30 moves at a predetermined equal velocity and the idle roller 32 rotates at a predetermined equal angular velocity. The control operation based on the feedback loop is repeated.

The target angular displacement Ref(i) can be prepared by a method similar to the method explained in the first embodiment.

While in the controller 2 of the second embodiment, the PI control system has been used as one example, the controller is not limited to this example. All the above calculations have been performed according to numerical value calculation in the microcomputer 21, which can be realized easily. The reference driving pulse frequency Refp_c is the number of pulses uniquely determined according to the angular velocity of the driving roller 31 based on the velocity of the belt 30 and the reduction ratio of the reduction system. In the second embodiment, it is also possible to arbitrarily select the number of pulses within a range where a step-out phenomenon does not occur during motor driving. The target angular displacement Ref(i) can be obtained easily by integrating the target equal angular velocity of the idle roller 32.

FIG. 8 is a block diagram of a drive controlling apparatus according to a modification of the first or the second embodiment. Although a case that the drive controlling apparatus of the first modification is applied to the belt apparatus of the second embodiment is explained below, the first modification can also be applied to the belt apparatus of the first embodiment. Explanation about portions similar to those in FIG. 2 regarding the first embodiment is omitted.

In FIG. 8, the difference e(i) between target angular displacement Ref(i) of the driving roller 31 and detection angular displacement P(i-1) of the driving roller 31 is inputted into the controller 2. The controller 2 includes a low pass filter 8 for removing high frequency noises and a proportional element (gain Kp) 9. In the controller 2, a correction amount to a reference driving pulse frequency used for driving the pulse motor 11 is obtained to be inputted into the calculator 7. In the calculator 7, the correction amount is added to a constant reference driving pulse frequency Refp_c, so that a driving pulse frequency u(i) is determined.

A third embodiment where the present invention is applied to a color copying machine is explained next with reference to the accompanying drawings.

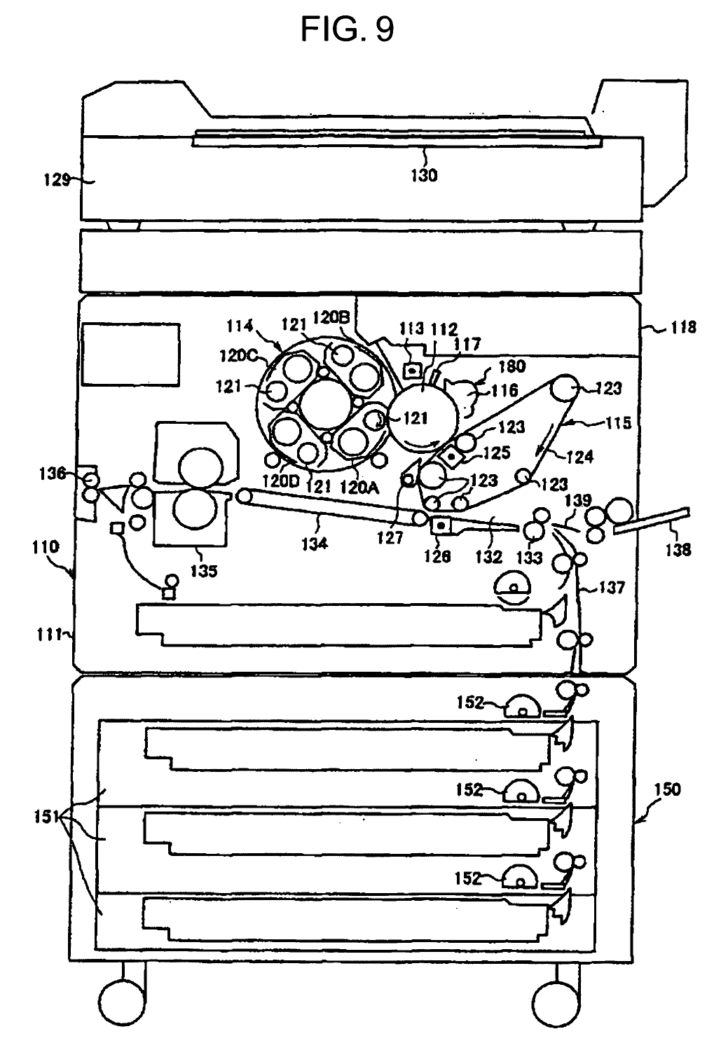

FIG. 9 is a schematic configuration view of a color copying machine according to the third embodiment. In FIG. 9, an apparatus main unit 110 of the color copying machine includes a drum-like photoconductor (hereinafter, “photosensitive drum”) 112 serving as image carrier slightly near to the left side from a center inside an exterior case 111. Around the photosensitive drum 112, a charger 113 disposed above the photosensitive drum 112, a rotary developing device 114 serving as a developing unit, an intermediate transfer unit 115, a cleaning device 116, an electricity remover 117, and the like are arranged along a rotating direction indicated by arrow (counterclockwise) in this order.

A light writing device serving as an exposing unit, for example, a laser writing device 118 is disposed above the charger 113, the rotary developing device 114, the cleaning device 116, and the electricity remover 117. The rotary developing device 114 includes developing elements 120A, 120B, 120C, and 120D, each element having a developing roller 121. The developing elements 120A, 120B, 120C, and 120D receive respective toners of yellow, magenta, cyan, and black. The rotary developing device is rotated about its center axis to selectively move one of the developing elements 120A, 120B, 120C, and 120D to a developing position facing an outer periphery of the photosensitive drum 112.

In the intermediate transfer unit 115, an intermediate transfer belt 124 serving as an endless intermediate transfer member is spanned around a plurality of rollers 123 and the intermediate transfer belt 124 is caused to contact with the photosensitive drum 112. A transfer device 125 is disposed inside the intermediate transfer belt 124, and another transfer device 126 and a cleaning device 127 are disposed outside the intermediate transfer belt 124. The cleaning device 127 is provided to be capable of approaching to and separating from the intermediate transfer belt 124.

The laser writing device 118 is inputted with image signals for respective colors from an image reader 129 via an image processor (not shown). Electrostatic latent image are formed on the photosensitive drum 112 by irradiating laser beams L sequentially modulated according to image signals for respective colors on the photosensitive drum 112 evenly charged to expose the photosensitive drum 112. The image reader 129 performs color separation on an image on an original G set on an original tray 130 provided on an upper face of the apparatus main unit 110 to read the image and convert the same to electric image signals. A recording medium conveying path 132 allows conveyance of a recording medium such as paper or a sheet from the left side to the light side. A registration roller pair 133 is disposed on the recording medium conveying path upstream of the intermediate transfer unit 115 and the transfer device 126. A conveying belt 134, a fusing device 135, and a paper discharge roller pair 136 are disposed downstream of the intermediate transfer unit 115 and the transfer device 126.

The apparatus main unit 110 is set on a paper feeding device 150. A plurality of paper feed trays are provided in a multi-tier manner inside the paper feeding device 150, and either one of paper feed rollers 152 is selectively driven so that a recording medium is fed from either one of paper feed cassettes 151. The recording medium is conveyed to the recording medium conveying path 132 via an automatic paper feed path 137 inside the apparatus main unit 110. A manual feed tray 138 is provided so as to be openable and closable on the right side of the apparatus main unit 110, where a recording medium inserted from the manual feed tray 138 is conveyed to the recording medium conveying path 132 via a manual feed path 139 inside the apparatus main unit 110. A paper discharge tray (not shown) is attachably and detachably mounted on the left side of the apparatus main unit 110, and a recording medium discharged by the paper discharge roller pair 136 via the recording medium conveying path 132 is received in the paper discharge tray.

In the color copying machine of the third embodiment, when a color copy is made, copying operation is performed by setting the original G on the original tray 130 and pressing a start button. First, the image reader 129 performs color separation to an image on the original G on the original tray 130 to read the image. Simultaneously, a recording medium is selectively fed from one of the paper feed cassettes 151 inside the paper feeding device 150 by a corresponding one of the paper feed rollers 152, and it passes through the automatic paper feed path 137 and the recording medium conveying path 132 to stop at the registration roller pair 133 by contacting thereto.

An electrostatic latent image on the photosensitive drum 112 rotates in a counterclockwise direction, while the intermediate transfer belt 124 rotates in a clockwise direction according to rotation of the driving roller of the plurality of rollers 123. The photosensitive drum 112 is evenly charged according to rotation thereof by the charger 113 and laser beam modulated by a first color image signal inputted into the laser writing apparatus 118 from the image reader 129 via the image processor is irradiated on the photosensitive drum 112 from the laser writing apparatus 118, so that an electrostatic latent image is formed on the photosensitive drum 112.

The electrostatic latent image on the photosensitive drum 112 is developed by the developing element 120A for the first color of the rotary developing device 114 to form a first color image, and the first color image on the photosensitive drum 112 is transferred to the intermediate transfer belt 124 by the transfer device 125. After the first color image is transferred, the photosensitive drum 112 is cleaned by the cleaning device 116 so that the residual toner is removed from the photosensitive drum 112, and electricity is removed from the photosensitive drum 112 by the electricity remover 117.

Subsequently, the photosensitive drum 112 is evenly charged by the charger 113, and laser beam modulated by a second color image signal inputted into the laser writing apparatus 118 from the image reader 129 via the image processor is irradiated on the photosensitive drum 112 from the laser writing apparatus 118, so that an electrostatic latent image is formed on the photosensitive drum 112. The electrostatic latent image on the photosensitive drum 112 is developed by the developing element 120B for the second color of the rotary developing device 114 to form a second color image. The second color image on the photosensitive drum 112 is transferred to the intermediate transfer belt 124 by the transfer device 125 such that it is superimposed on the first color image. After the second color image is transferred, the photosensitive drum 112 is cleaned by the cleaning device 116 so that the residual toner is removed from the photosensitive drum 112, and electricity is removed from the photosensitive drum 112 by the electricity remover 117.

The photosensitive drum 112 is evenly charged by the charger 113, and laser beam modulated by a third color image signal inputted into the laser writing apparatus 118 from the image reader 129 via the image processor is irradiated on the photosensitive drum 112 from the laser writing apparatus 118, so that an electrostatic latent image is formed on the photosensitive drum 112. The electrostatic latent image on the photosensitive drum 112 is developed by the developing element 120C for the third color of the rotary developing device 114 to form a third color image. The third color image on the photosensitive drum 112 is transferred to the intermediate transfer belt 124 by the transfer device 125 such that it is superimposed on the first color image and the second image. After the third color image is transferred, the photosensitive drum 112 is cleaned by the cleaning device 116 so that the residual toner is removed from the photosensitive drum 112, and electricity is removed from the photosensitive drum 112 by the electricity remover 117.

Furthermore, the photosensitive drum 112 is evenly charged by the charger 113, and laser beam modulated by a fourth color image signal inputted into the laser writing apparatus 118 from the image reader 129 via the image processor is irradiated on the photosensitive drum 112 from the laser writing apparatus 118, so that an electrostatic latent image is formed on the photosensitive drum 112. The electrostatic latent image on the photosensitive drum 112 is developed by the developing element 120D for the third color of the rotary developing device 114 to form a fourth color image. The fourth color image on the photosensitive drum 112 is transferred to the intermediate transfer belt 124 by the transfer device 125 such that it is superimposed on the first color image, the second image, and the third. After the fourth color image is transferred, the photosensitive drum 112 is cleaned by the cleaning device 116 so that the residual toner is removed from the photosensitive drum 112, and electricity is removed from the photosensitive drum 112 by the electricity remover 117.

The registration roller 133 is rotated timely to feed the recording medium and the recording medium is transferred with a full color image on the intermediate transfer belt 124 by the transfer device 126. The recording medium is conveyed by the conveying belt 134, the full color image thereon is fused by the fusing device 135, and the recording medium with the fused image is discharged to the paper discharge tray by the paper discharge roller pair 136. After the full color image is transferred, the intermediate transfer belt 124 is cleaned by the cleaning device 127 so that the residual toner is removed.

The operation for forming an image with four-color superimposition has been explained above. When an image with three-color superimposition is formed, three different single images are sequentially formed on the photosensitive drum 112 and they are transferred on the intermediate transfer belt 124 in a superimposing manner. Thereafter, these images are collectively transferred on a recording medium. Furthermore, when an image with two-color superimposition is formed, two different single images are sequentially formed on the photosensitive drum 112 and they are transferred on the intermediate transfer belt 124 in a superimposing manner. Thereafter, these images are collectively transferred on a recording medium. When a single-color image is formed, one single-color image is formed on the photosensitive drum 112 and, after being transferred on the intermediate transfer belt 124, the image is transferred on a recording medium.

In the color copying machine as described above, rotation precision of the intermediate transfer belt 124 considerably influences on the quality of a final product or image. In the color copying machine of the third embodiment, therefore, driving of the driving roller of the rollers 123 around which the intermediate transfer belt 124 is spanned is performed using the belt drive controlling apparatus shown in FIG. 3 or FIG. 7, to rotationally drive the intermediate transfer belt 124 with high precision.

A fourth embodiment where the present invention is applied to a color copying machine is explained next with reference to the accompanying drawings.

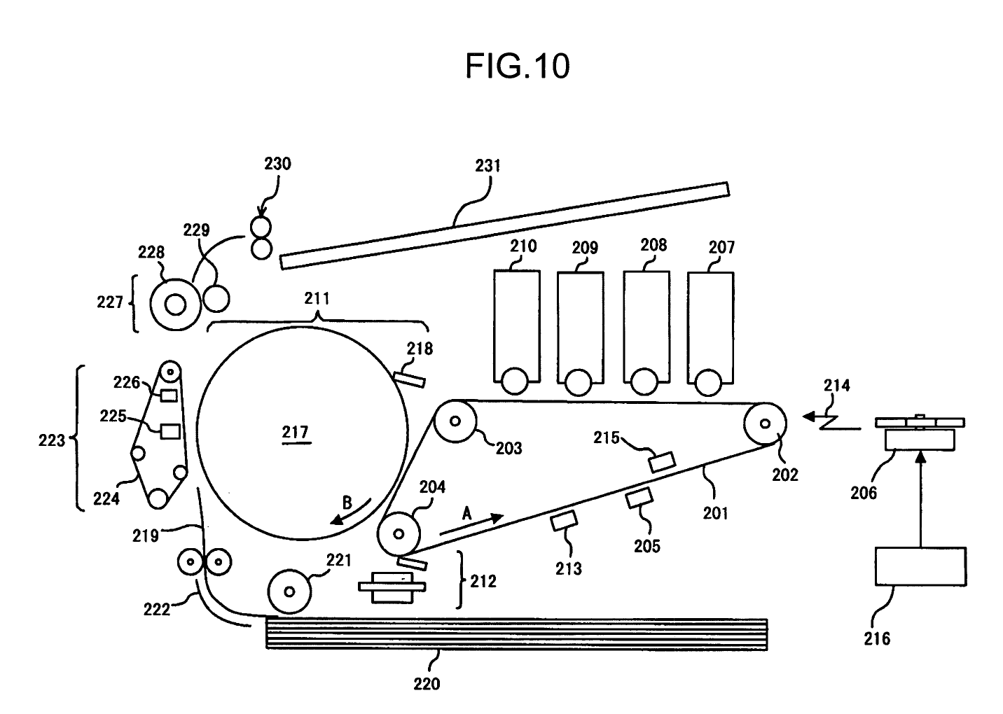

FIG. 10 is a schematic configuration diagram of a color copying machine according to the fourth embodiment. In FIG. 10, a photosensitive belt 201 serving as a latent image carrier is an endless photosensitive belt where a photosensitive layer such as organic photo semiconductor (OPC) is formed in a thin film on an outer peripheral face of a closed-loop belt base member made of nylon (NL). The photosensitive belt 201 is supported by three photoconductor conveying rollers 202 to 204 serving as supporting and rotating members and is rotationally moved in a direction of arrow A by a driving motor (not shown).

A charger 205, an exposure optical system (hereinafter, “LSU”) 206 as an exposing unit, developing elements 207 to 210 corresponding to respective colors of black, yellow, magenta, and cyan, an intermediate transfer unit 211, photoconductor cleaning unit 212, and an electricity remover 213 are arranged around the photosensitive belt 201 in this order along a rotational direction of the photosensitive belt shown by arrow A. The charger 205 is applied with a high voltage of about −4 to 5 Kilovolts from a power source (not shown), and it charges a portion of the photosensitive belt 201 facing the charger 205 to give evenly charged potential thereto.

The LSU 206 obtains exposure beams 214 by sequentially performing light intensity modulation or pulse width modulation on image signals for respective colors from a gradation converter (not shown) using a laser driving circuit (not shown) to drive a semiconductor laser (not shown) using the modulated signal and it scans the photosensitive belt 201 with the exposure beams 214, thereby sequentially forming electrostatic latent images corresponding to image signals for respective colors on the photosensitive belt 201. A seam sensor 215 detects seams on the photosensitive belt 201 formed in a loop. When the seam sensor 215 detects a seam on the photosensitive belt 201, the timing controller 216 controls beam emitting timing of the LSU 206 so as to avoid the seam on the photosensitive belt 201 and such that electrostatic latent image forming angular displacements for respective colors become equal.

The respective developing elements 207 to 210 accommodate toners corresponding to respective colors and they selectively contact with the photosensitive belt 201 at timings corresponding to image signals for respective colors on the photosensitive belt 201 to develop electrostatic latent images on the photosensitive belt 201 using toners to form images for the respective colors, thereby forming a full color image of an image with four-color superimposition.

The intermediate transfer unit 211 includes a drum-like intermediate transfer member (a transfer drum) 217 constituted by winding a belt-like sheet formed from electrically conductive resin or the like on a raw tube made from metal such as aluminum, and an intermediate transfer member cleaning unit 218 formed in a blade shape from rubber or the like, where the intermediate transfer member cleaning unit 218 is separated from the intermediate transfer member 217 while an image with four-color superimposition is being formed on the intermediate transfer member 217. The intermediate transfer member cleaning unit 218 contacts with the intermediate transfer member 217, only when it cleans the intermediate transfer member 217, so that the residual toner that has not been transferred from the intermediate transfer member 217 to a recording paper 19 serving as the recording medium is removed. The recording papers are fed one by one from a recording cassette 220 to a paper conveying path 222.

The transfer unit 223 transfers a full color image on the intermediate transfer member 217 to a recording paper or sheet 219, and it includes a transfer belt 224 obtained by forming an electrically conductive rubber or the like in a belt shape, a transfer element 225 that applies transfer bias for transferring a full color image on the intermediate transfer member 217 to a recording paper 219 to the intermediate transfer member 217, and a separator 226 that applies bias to the intermediate transfer member 217 to prevent the recording paper 219 from being electrostatically attracted to the intermediate transfer member 217 after the full color image has been transferred to the recording paper 219.

The fusing unit 227 includes a heat roller 228 having a heat source therein and a pressurizing roller 229, where a full color image is formed by imparting heat and pressure on the recording paper 219 according to rotations of the heat roller 228 and the pressurizing roller 229 nipping the recording paper to fuse the full color image transferred on the recording paper 219 on the recording paper 219.

The color copying machine thus configured takes the following operation. An explanation is given here, assuming that developments of electrostatic latent images are performed in the order of black, cyan, magenta, and yellow.

The photosensitive belt 201 and the intermediate transfer member 217 are driven in directions of arrows A and B by respective driving sources (not shown). In a driving condition of the belt 201 and the member 217, a high voltage of about −4 to 5 Kilovolts is applied to the charger 205 from a power source (not shown) and a surface of the photosensitive belt 201 is evenly charged to about −700 Volts by the charger 205. After a predetermined time elapsing from detection of the seam on the photosensitive belt 201 made by the seam sensor 215 for avoiding the seam on the photosensitive belt 201, exposure light 214 of a laser beam corresponding to an image signal for black is irradiated to the photosensitive belt 201 from the LSU 206, so that charges on a portion of the photosensitive belt 201 on which the exposure light 214 has been irradiated are neutralized and an electrostatic latent image is formed.

On the other hand, the black developing element 207 is brought in contact with the photosensitive belt 201 at a predetermined timing. Black toner in the black developing element 207 is negatively charged in advance, and black toner is adhered to only a portion (an electrostatic latent image portion) of the photosensitive belt 201 that is neutralized by irradiating the exposure light 214, that is, developing is performed according to a so-called “negative-positive process”. A black toner image formed on a surface of the photosensitive belt 201 by the black developing element 207 is transferred on the intermediate transfer member 217. The residual toner that has not been transferred to the intermediate transfer member 217 from the photosensitive belt 201 is removed by the photoconductor cleaning unit 212, and charges on the photosensitive belt 201 are removed by the electricity remover 213.

A surface of the photosensitive belt 201 is evenly charged to about −700 Volts by the charger 205. After a predetermined time elapsing from detection of the seam on the photosensitive belt 201 made by the seam sensor 215 for avoiding the seam on the photosensitive belt 201, exposure light 214 of a laser beam corresponding to an image signal for cyan is irradiated to the photosensitive belt 201 from the LSU 206, so that charges on a portion of the photosensitive belt 201 on which the exposure light 214 has been irradiated are neutralized and an electrostatic latent image is formed.

On the other hand, the cyan developing element 208 is brought in contact with the photosensitive belt 201. Cyan toner in the cyan developing element 208 is negatively charged in advance, and cyan toner is adhered to only a portion (an electrostatic latent image portion) of the photosensitive belt 201 that is neutralized by irradiating the exposure light 214, that is, developing is performed according to a so-called “negative-positive process”. A cyan toner image formed on a surface of the photosensitive belt 201 by the cyan developing element 208 is transferred on the intermediate transfer member 217 in superimposition with the black toner image. The residual toner that has not been transferred to the intermediate transfer member 217 from the photosensitive belt 201 is removed by the photoconductor cleaning unit 212, and charges on the photosensitive belt 201 are removed by the electricity remover 213.

A surface of the photosensitive belt 201 is evenly charged to about −700 Volts by the charger 205. After a predetermined time elapsing from detection of the seam on the photosensitive belt 201 made by the seam sensor 215 for avoiding the seam on the photosensitive belt 201, exposure light 214 of a laser beam corresponding to an image signal for magenta is irradiated to the photosensitive belt 201 from the LSU 206, so that charges on a portion of the photosensitive belt 201 on which the exposure light 214 has been irradiated are neutralized and an electrostatic latent image is formed.

On the other hand, the magenta developing element 209 is brought in contact with the photosensitive belt 201. Magenta toner in the magenta developing element 209 is negatively charged in advance, and magenta toner is adhered to only a portion (an electrostatic latent image portion) of the photosensitive belt 201 that is neutralized by irradiating the exposure light 214, that is, developing is performed according to a so-called “negative-positive process”. A magenta toner image formed on a surface of the photosensitive belt 201 by the magenta developing element 209 is transferred on the intermediate transfer member 217 in superimposition with the black toner image and the cyan toner image. The residual toner that has not been transferred to the intermediate transfer member 217 from the photosensitive belt 201 is removed by the photoconductor cleaning unit 212, and charges on the photosensitive belt 201 are removed by the electricity remover 213.

Furthermore, a surface of the photosensitive belt 201 is evenly charged to about −700 Volts by the charger 205. After a predetermined time has elapsed from detection of the seam on the photosensitive belt 201 made by the seam sensor 215 for avoiding the seam on the photosensitive belt 201, exposure light 214 of a laser beam corresponding to an image signal for yellow is irradiated to the photosensitive belt 201 from the LSU 206, so that charges on a portion of the photosensitive belt 201 on which the exposure light 214 has been irradiated are neutralized and an electrostatic latent image is formed.

On the other hand, the yellow developing element 210 is brought in contact with the photosensitive belt 201. Yellow toner in the yellow developing element 210 is negatively charged in advance, and yellow toner is adhered to only a portion (an electrostatic latent image portion) of the photosensitive belt 201 that is neutralized by irradiating the exposure light 214, that is, developing is performed according to a so-called “negative-positive process”. A yellow toner image formed on a surface of the photosensitive belt 201 by the yellow developing element 210 is transferred on the intermediate transfer member 217 in superimposition with the black toner image, the cyan toner image, and the magenta toner image. The residual toner that has not been transferred to the intermediate transfer member 217 from the photosensitive belt 201 is removed by the photoconductor cleaning unit 212, and charges on the photosensitive belt 201 are removed by the electricity remover 213.

The transfer unit 223 that is being separated from the intermediate transfer member 217 by that time is brought in contact with the intermediate transfer member 217 and a high voltage of about +1 Kilovolt is applied from the power source (not shown) to the transfer element 225 so that a full color image formed on the intermediate transfer member 217 is collectively transferred on a recording paper 219 conveyed along the paper conveying path 222 from the recording paper cassette 225 by the transfer element 225.

A voltage is applied from the power source such that an electrostatic force attracting the recording paper 219 works, so that recording paper 219 is separated from the intermediate transfer member 217. Subsequently, the recording paper 219 is fed to the fuser 227, where the full color image is fused utilizing a nipping force between the heat roller 228 and the pressurizing roller 229 and heat from the heat roller 228, and the recording paper 219 with the fused full color image is discharged to a paper discharge tray 231 by a paper discharge roller pair 230.

The residual toner on the intermediate transfer member 217 that has not been transferred on the recording paper 219 by the transfer unit 226 is removed from the intermediate transfer member 217. The intermediate transfer member cleaning unit 218 is positioned at an angular displacement position where it is separated from the intermediate transfer member 217 until a full color image is obtained. After the full color image has been transferred on the recording paper 219, the intermediate transfer member cleaning unit 218 contacts with the intermediate transfer member 217 to remove the residual toner on the intermediate transfer member 217. One full color image corresponding to one paper is formed according the series of operations described above.

In such a color copying machine, rotational precision of the photosensitive belt 201 significantly influences on the quality of a final image. Therefore, it is particularly desired to precisely drive the photosensitive belt 201 with high precision. In the color copying machine of the fourth embodiment, therefore, driving of the driving roller of the photosensitive belt conveying rollers 202 to 204 around which the photosensitive belt 201 is spanned is performed using the belt drive controlling apparatus shown in FIG. 3 or FIG. 7, to rotationally drive the photosensitive belt 201 with high precision.

A fifth embodiment where the present invention is applied to a color copying machine is explained next with reference to the accompanying drawings.

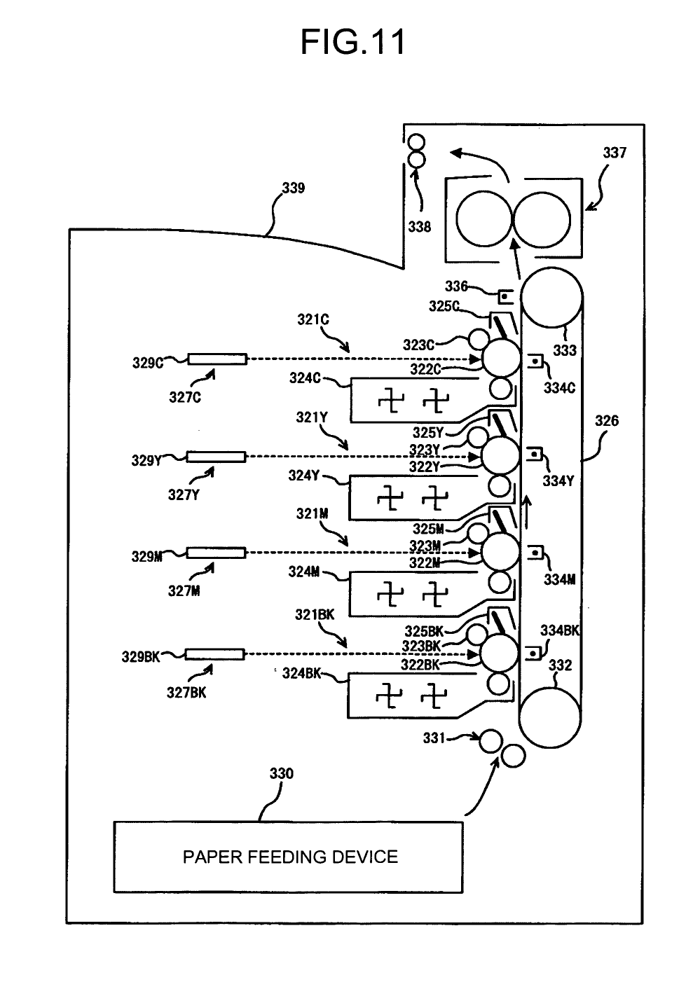

FIG. 11 is a schematic configuration diagram of a color copying machine according to the fifth embodiment. In FIG. 11, a plurality of image forming units 321Bk, 321M, 321Y, and 321C that form respective images for, for example, black (Bk), magenta (M), yellow (Y), and cyan (C), respectively are arranged in a vertical direction, and the image forming units 321Bk, 321M, 321Y, 321C have drum-like photoconductors or photosensitive drums 322Bk, 322M, 322Y, 322C, chargers (for example, contact type chargers) 323Bk, 323M, 323Y, 323C, developing devices 324Bk, 324M, 324Y, 324C, cleaning devices 325Bk, 325M, 324Y, 325C, and the like.

The photoconductors 322Bk, 322M, 322Y, 322C are arranged in a vertical direction so as to face an endless conveying transfer belt 326, and they are rotated at the same peripheral velocity as that of the endless conveying transfer belt 326. After the photoconductors 322Bk, 322M, 322Y, 322C are evenly charged by the chargers 323Bk, 323M, 323Y, 323C, they are exposed by exposing units 327Bk, 327M, 327Y, 327C including light writing devices so that electrostatic latent images are formed on the photoconductors 322Bk, 322M, 322Y, 322C, respectively.

The light writing devices 327Bk, 327M, 327Y, 327C form electrostatic latent images on the photoconductors 322Bk, 322M, 322Y, 322C by driving semiconductor lasers by semiconductor laser driving circuits according to image signals for respective color of Bk, M, Y, C to deflect and scan laser beams from the semiconductor lasers using polygon mirrors 329Bk, 329M, 329Y, 329C and imaging respective laser beams from the polygon mirrors 329Bk, 329M, 329Y, 329C on the photoconductors 322Bk, 322M, 322Y, 322C via fθ lenses or mirrors (not shown).

The electrostatic latent images on the photoconductors 322Bk, 322M, 322Y, 322C are respectively developed by the developing devices 324Bk, 324M, 324Y, 324C to form toner images corresponding to respective colors of Bk, M, Y, C. Therefore, the charges 323Bk, 323M, 323Y, 323C, the light writing devices 327Bk, 327M, 327Y, 327C, and the developing devices 324Bk, 324M, 324Y, 324C constitute image forming units that form images (toner images) corresponding to respective colors of Bk, M, Y, C on the photoconductors 322Bk, 322M, 322Y, 322C.

On the other hand, a transfer paper such as a plain paper, an over head projector (OHP) sheet is fed to a registration roller pair 331 from a paper feeding device 330 installed on a lower portion of the image forming apparatus and constituted using a paper feed cassette along a transfer paper conveying path, and the transfer paper is fed to a transfer nip formed between the endless conveying and transferring belt 326 and the photoconductor 322Bk from the registration roller pair 331 in timing with the toner image on the photoconductor Bk in the image forming unit corresponding to the first color (an image forming unit that first transfers an image on a photoconductor to a transfer paper).

The conveying and transferring belt 326 is spanned around a driving roller 332 and an idle roller 333 arranged in a vertical direction, and the driving roller 332 is rotationally driven by a driving unit (not shown) so that the conveying and transferring belt 326 is rotated at the same peripheral velocity as those of the photoconductors 322Bk, 322M, 322Y, 322C. The transfer paper fed from the registration roller pair 331 is conveyed by the conveying and transferring belt 326, and toner images for respective colors of Bk, M, Y, C on the photoconductors 322Bk, 322M, 322Y, 322C are sequentially transferred on the transfer paper according to actions of electric fields formed by transfer units 334Bk, 334M, 334Y, 334C including corona dischargers so that a full color image is formed on the transfer paper. Simultaneously, the transfer paper is conveyed reliably, while being electrostatically attracted to the conveying and transferring belt.

After the transfer paper is neutralized by a separating unit 236 including a separating charger to be separated from the conveying and transferring belt 326, the transfer paper is fused with the full color image by the fusing device 237 to be discharged, by a paper discharge roller pair 338, to a paper discharge tray 239 provided on an upper portion of the color copying machine of the fifth embodiment. After the toner images are transferred, the photoconductors 322Bk, 322M, 322Y, 322C are cleaned by the cleaning devices 325Bk, 325M, 324Y, 325C and they are prepared for the next image forming operation.

In such a color copying machine, rotational precision of the conveying and transferring belt 326 significantly influences on the quality of a final image, and it is desired to control driving of the conveying and transferring belt 326 further precisely. In the color copying machine of the fifth embodiment, therefore, driving of the driving roller 333 around which the conveying and transferring belt 326 is spanned is performed using the belt drive controlling apparatus shown in FIG. 3 or FIG. 7, to rotationally drive the conveying and transferring belt 326 with high precision.

A sixth embodiment where the present invention is applied to an image reader is explained next with reference to the accompanying drawings.

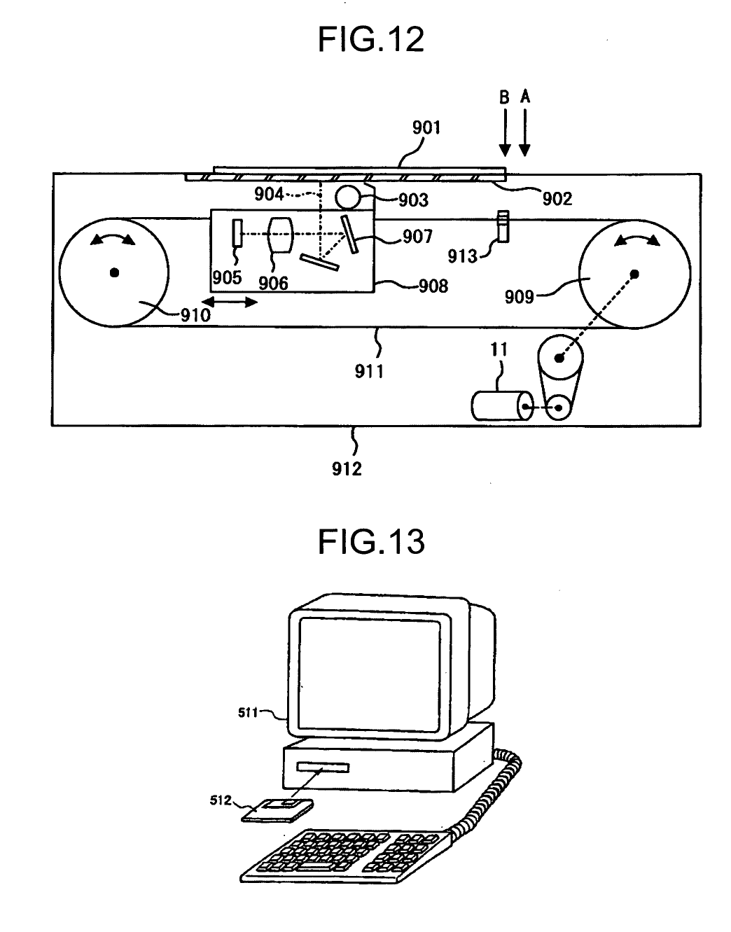

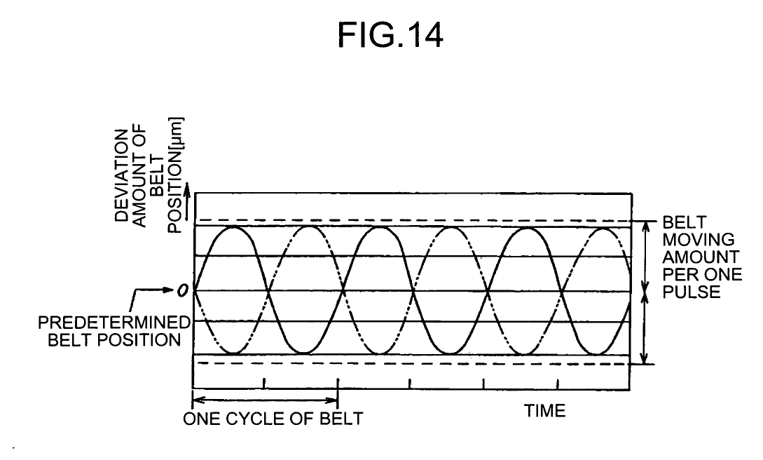

FIG. 12 is a schematic configuration diagram of an image reader according to the sixth embodiment. The image reader includes an original tray 902 on which an original 901 is placed, an original illuminating system 903 that illuminates light on the original 901, and a photoelectric converting unit 908 that is a moving member for reading an original. Furthermore, the image reader includes pulleys 909, 910 for sub-scan driving, a wire 911, a pulse motor 11 serving as a driving source, and a housing 912. The photoelectric converting unit 908 includes a charge coupled device (CCD) 905, an imaging lens 906, a full reflecting mirror 907, and the like. The photoelectric converting unit 908 performs diving in a sub-scanning direction of the original 901 using a driving force transmitting unit including the pulse motor 11 fixed on the housing 912, the wire 911, the pulleys 909, 910, and the like. At that time, the original 901 on the original tray 902 is illuminated by the original illuminating system 903 such as a fluorescent lamp, a reflected beam from the original 901 (indicated by an optical axis 904) is folded back by a plurality of mirrors 907, and an image on the original 901 is imaged on a light receiving portion of the CCD 905 via a imaging lens 906. A whole original is read by scanning a whole face of the original 901 using the photoelectric converting unit 908. A sensor 913 indicating reading start angular displacement is provided below an end of the original 901. Furthermore, the photoelectric converting unit 908 is designed so as to become a steady condition of a rising equal velocity before it reaches a reading start angular displacement B from its home position A. After the photoelectric converting unit 908 reaches the point A, reading starts.

In the image reader thus configured, moving precision of the photoelectric converting unit 908 that is the moving member significantly influences on the quality of a final image, and it is desired to control driving of the photoelectric converting unit 908 further precisely. In the color copying machine of the sixth embodiment, therefore, driving of the driving pulley of the two pulleys 909, 910 around which the wire 911 for driving the photoelectric converting unit 908 is spanned is performed using the belt drive controlling apparatus shown in FIG. 3 or FIG. 7, to rotationally drive the photoelectric converting unit 908 with high precision.

Driving control in each of the above embodiments can be performed using a computer. FIG. 13 is a schematic of a personal computer 511 that is one example of computers usable for performing the driving control of each embodiment. A computer program that causes the personal computer 511 to execute calculations for controlling and data input/output in the personal computer 511 is stored in a storage medium 512 attachable to and detachable from the personal computer 511. The personal computer 511 can perform driving control in the above embodiment by executing the computer program stored in the storage medium 512. The storage medium 512 can include an optical disk such as a CD-ROM, and a magnetic disk such as a flexible disk. The computer program can be read by the personal computer 511 via a communication network without using a storage medium.

A microcomputer can be used as the computer. The microcomputer can be assembled for using in each of the image forming apparatuses shown in FIG. 9 to 11 or the image reader shown in FIG. 12. In this case, as the storage medium storing the control program, a ROM in the microcomputer can be used.

Specifically, the computer program can include the following ones. In the first or the second embodiment, for example, it is a control program for rotationally driving the belt 30 executed by a computer can be used as the program. In the third embodiment, it is a control program for controlling the belt apparatus that drives the intermediate transfer belt 124 in the image forming apparatus. In the fourth embodiment, it is a control program for controlling the belt apparatus that drives the photosensitive belt 201 in the image forming apparatus, which is executed by a computer. In the fifth embodiment, it is a control program for controlling the belt apparatus that drives the conveying and transferring belt 326 in the image forming apparatus, which is executed by a computer. In the sixth embodiment, it is a control program for controlling the moving member driving device (the belt apparatus) that drives the photoelectric converting unit 908 in the image reader, which is executed by a computer.

According to each of the above embodiments, by setting a target angular displacement Ref(i) to cancel velocity fluctuation due to a minute belt velocity fluctuation component caused by thickness fluctuation of the belt and performing accumulation position control such that a belt position in a belt surface-moving direction approaches to the target value, the velocity fluctuation due to a minute belt velocity fluctuation component caused by thickness fluctuation of the belt can be reduced. Accordingly, the minute velocity fluctuation generated during belt driving can be suppressed without using a reduction mechanism with a high reduction ratio.

Particularly, according to the modification, the unit for obtaining the correction amount to the reference driving pulse frequency from the difference between the target angular displacement and the detection angular displacement or the difference between the target displacement and the detection displacement in the controller 2 is configured by the low pass filter 8 and the proportional element 9. By configuring the unit for obtaining the correction amount by the low pass filter 8 and the proportional element 9 in this manner, the configuration of the drive controlling apparatus can be made simpler than that using a PI control system, while such a phenomenon that control becomes unstable due to high frequency noises is avoided, and cost reduction can be further achieved.

Particularly, according to the third embodiment, driving of the driving roller for the intermediate transfer belt 124 in the color copying machine is controlled using the drive controlling apparatus according to the first or the second embodiment. Accordingly, the accuracy of the rotational drive of the intermediate transfer belt 124 at an equal angular velocity is improved, so that a high quality color image that does not include out of color registration or the like can be formed.

Particularly, according to the fourth embodiment, driving of the driving roller for the photosensitive belt 201 in the tandem type color copying machine is controlled using the drive controlling apparatus according to the first or the second embodiment. Accordingly, the accuracy of the equal angular velocity drive of the photosensitive belt 201 is improved, so that a high quality color image that does not include out of color registration or the like can be formed.

Particularly, according to the fifth embodiment, driving of the driving roller 332 for the conveying and transferring belt 326 in the color copying machine is controlled using the drive controlling apparatus of the first or the second embodiment. Accordingly, accuracy of the equal angular velocity rotational drive of the conveying and transferring belt 326 is improved, so that a high quality color image that does not include out of color registration or the like can be formed.

Particularly, according to the sixth embodiment, driving of the photoelectric converting unit 908 that is the moving member in the image reader is controlled using the drive controlling apparatus of the first or the second embodiment. Accordingly, the accuracy of the equal velocity drive of the photoelectric converting unit 908 moving along an image face on an original is improved, so that high quality image reading can be made possible.

The drive controlling apparatus of the present invention can be used without liming its use to the equal angular velocity drive for the belt in the image forming apparatus or the image reader, or the equal velocity drive for the moving member. For example, the drive controlling apparatus of the present invention can also be applied for controlling driving of an optical disk drive (ODD), a hard disk drive (HDD) or a moving unit or a rotating unit in a robot or the like

According to the present invention, minute velocity fluctuation of a belt that occurs during driving of the belt can be suppressed without needing a reduction mechanism with a high reduction ratio.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of controlling driving of an endless belt spanned around at least one driving member and at least one supporting member, the driving member being driven by a pulse motor, comprising:
detecting angular displacement of at least one of the driving member and the supporting member;
calculating a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse;
calculating a frequency of a driving pulse used to drive the pulse motor based on the difference and a reference driving pulse frequency; and
driving the pulse motor based on a driving pulse with calculated frequency.

2. The belt drive controlling apparatus according to claim 1, wherein the specific velocity fluctuation component is produced due to variation in a thickness of the belt in a direction of movement of the belt.

3. A belt drive controlling apparatus that controls driving of an endless belt spanned around at least one driving member and at least one supporting member, the driving member being driven by a pulse motor, comprising:
an angular displacement detecting unit that detects detecting angular displacement of at least one of the driving member and the supporting member;
a difference calculating unit that calculates a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse;
a frequency calculating unit that calculates a frequency of a driving pulse used to drive the pulse motor based on the difference and a reference driving pulse frequency; and
a driving unit that controls driving of the pulse motor based on a driving pulse with calculated frequency.

4. The belt drive controlling apparatus according to claim 3, wherein the specific velocity fluctuation component is produced due to variation in a thickness of the belt in a direction of movement of the belt.

5. The belt drive controlling apparatus according to claim 3, wherein
the difference calculating unit outputs a waveform signal indicating the difference,
the belt drive controlling apparatus further comprises a low pass filter configured to shape the waveform signal, and
the frequency calculating unit uses an output of the low pass filter as the difference.

6. The belt drive controlling apparatus according to claim 3, wherein the angular displacement detecting unit includes a rotary encoder.

7. The belt drive controlling apparatus according to claim 3, wherein the angular displacement detecting unit includes a linear encoder.

8. The belt drive controlling apparatus according to claim 3, wherein the supporting member includes an idle supporting member, and
the angular displacement detecting unit detects angular displacement of the idle supporting member.

9. The belt drive controlling apparatus according to claim 3, wherein the angular displacement detecting unit detects an angular displacement of the driving member.

10. A belt apparatus comprising:
an endless belt spanned around at least one driving member and at least one supporting member;
a drive controlling apparatus that controls driving of the belt; and
a pulse motor that drives the driving member under the control of the drive controlling apparatus, wherein the belt drive controlling apparatus includes
an angular displacement detecting unit that detects detecting angular displacement of at least one of the driving member and the supporting member;
a difference calculating unit that calculates a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse;
a frequency calculating unit that calculates a frequency of a driving pulse used to drive the pulse motor based on the difference and a reference driving pulse frequency; and
a driving unit that controls driving of the pulse motor based on a driving pulse with calculated frequency.

11. An image forming apparatus comprising:
a latent image carrier;
a latent image forming unit that forms a latent image on the latent image carrier;
a developing unit that develops the latent image formed on the latent image carrier;
a recording member conveying member that conveys a recording member; and
a transfer unit that transfers developed image from the latent image carrier to a recording member, wherein the recording member conveying member includes a belt apparatus and the belt apparatus includes
an endless belt spanned around at least one driving member and at least one supporting member that conveys the recording member;
a drive controlling apparatus that controls driving of the belt; and
a pulse motor that drives the driving member under the control of the drive controlling apparatus, wherein the belt drive controlling apparatus includes
an angular displacement detecting unit that detects detecting angular displacement of at least one of the driving member and the supporting member;
a difference calculating unit that calculates a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse;
a frequency calculating unit that calculates a frequency of a driving pulse used to drive the pulse motor based on the difference and a reference driving pulse frequency; and
a driving unit that controls driving of the pulse motor based on a driving pulse with calculated frequency.

12. An image forming apparatus comprising:
a latent image carrier including an endless belt spanned around at least one driving member and at least one supporting member;
a latent image forming unit that forms a latent image on the latent image carrier;
a developing unit that develops the latent image formed on the latent image carrier;
a transfer unit that transfers developed image from the latent image carrier to a recording member; and
a belt apparatus that drives the belt and includes
a drive controlling apparatus that controls driving of the belt; and
a pulse motor that drives the driving member under the control of the drive controlling apparatus, wherein the belt drive controlling apparatus includes
an angular displacement detecting unit that detects detecting angular displacement of at least one of the driving member and the supporting member;
a difference calculating unit that calculates a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse;
a frequency calculating unit that calculates a frequency of a driving pulse used to drive the pulse motor based on the difference and a reference driving pulse frequency; and
a driving unit that controls driving of the pulse motor based on a driving pulse with calculated frequency.

13. An image forming apparatus comprising:
a latent image carrier;
a latent image forming unit that forms a latent image on the latent image carrier;
a developing unit that develops the latent image formed on the latent image carrier;
an intermediate transfer member that includes a belt apparatus;
a first transfer unit that transfers developed image from the latent image carrier to the intermediate transfer member; and
a second transfer unit that transfers developed image from the intermediate transfer member to a recording member, wherein
the belt apparatus includes
an endless belt spanned around at least one driving member and at least one supporting member that conveys the recording member;
a drive controlling apparatus that controls driving of the belt; and
a pulse motor that drives the driving member under the control of the drive controlling apparatus, wherein the belt drive controlling apparatus includes
an angular displacement detecting unit that detects detecting angular displacement of at least one of the driving member and the supporting member;
a difference calculating unit that calculates a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse;
a frequency calculating unit that calculates a frequency of a driving pulse used to drive the pulse motor based on the difference and a reference driving pulse frequency; and
a driving unit that controls driving of the pulse motor based on a driving pulse with calculated frequency.

14. A computer-readable recording medium that stores therein a computer program that causes a computer to implement method of controlling driving of an endless belt spanned around at least one driving member and at least one supporting member, the driving member being driven by a pulse motor, the computer program causing the computer to execute:
detecting angular displacement of at least one of the driving member and the supporting member;
calculating a difference between detected angular displacement and a target angular displacement, wherein the target angular displacement is set so as to cancel a specific velocity fluctuation component of a surface velocity of the belt produced when the drive member is rotated at a constant angular velocity and that is smaller than amount of surface movement of the belt in one driving pulse;
calculating a frequency of a driving pulse used to drive the pulse motor based on the difference and a reference driving pulse frequency; and
driving the pulse motor based on a driving pulse with calculated frequency.
